(19) United States
(12) Patent Application Publication
(10) Pub. No.: US 2022/0389179 A1
(43) Pub. Date: Dec. 8, 2022

(54) HYDROGEL LIQUID PRECURSOR, METHOD OF MANUFACTURING HYDROGEL FABRICATION PRODUCT, AND HYDROGEL FABRICATION PRODUCT

(71) Applicant: Ricoh Company, Ltd., Tokyo (JP)

(72) Inventors: Takashi Matsumura, Kanagawa (JP); Tatsuya Niimi, Shizuoka (JP); Takuya Saito, Kanagawa (JP)

(73) Assignee: Ricoh Company, Ltd., Tokyo (JP)

(21) Appl. No.: 17/755,417

(22) PCT Filed: Nov. 26, 2020
(86) PCT No.: PCT/IB2020/061165

§ 371 Date: Apr. 28, 2022

(30) Foreign Application Priority Data
Nov. 29, 2019 (JP) 2019-216938

(51) Int. Cl. C08J 7/04; C08J 3/075; C08F 30/08

(52) U.S. Cl. CPC C08J 7/042; C08J 3/075; C08F 30/08; C08J 2343/04; B33Y 10/00

(57) ABSTRACT

A hydrogel liquid precursor contains water and one of a compound and a salt of the compound represented by R₁CH═CR₂X, where X represents a carboxyl group, carboxylate group, sulfo group, or sulfonate group, R₁ and R₂ each independently represent hydrogen atoms, alkyl groups, aryl groups, carboxyl groups, or alkylcarboxy groups.

### TECHNICAL FIELD

The present disclosure relates to a hydrogel liquid precursor, a method of manufacturing hydrogel fabrication product, and a hydrogel fabrication product.

### BACKGROUND ART

The technology of fabricating solid freeform objects has advanced rapidly and manufacturers are using various 3D printers utilizing methods such as fused deposition modeling, binder jetting, stereolithography, selective laser sintering, and material jetting. Also, fabrication applications handling various materials such as metal and resin have been proposed and are expected to be useful in medical or health care business in addition to industrial settings. This is because 3D data is readily obtained from images obtained by a 3D scanner, computerized tomography (CT), magnetic resonance imaging (MRI) and users are able to elaborately manufacture solid freeform fabrication products based on the data suit to their demands using 3D printers.

3D printers can be used to manufacture hearing aids and artificial legs that should be manufactured on a basis of individual unique forms as specific applications in the medical and health care businesses. In the biomedical applications, these 3D fabrication technologies are actively utilized to fabricate artificial bones for implant made of materials such as titanium, hydroxyapatite, and PEEK and study producing artificial organs by directly stacking cells on each other. For operation training and simulations in the medical field, application of this technology is proceeding to form imitations of real organs as models for practicing surgical procedure. Development of medical equipment is also advancing. Owing to such advanced equipment, medical is changing from cutting of or into body tissues or organs and removing large affected areas to minimally invasive treatment with catheter, endoscope, and robot assistance, which is less burden on patients. However, using such medical equipment requires great deal of skills and techniques to properly perform surgery operations, so that medical staff is aware of the necessity of training using the models for practicing surgical procedure for them to prevent medical accidents. Such models would reproduce the detail of an affected area and provide chances of close simulations before rare and difficult operations.

Acrylic or urethane resin models fabricated by a 3D printer or silicone models manufactured by using a casting mold have been used for the models.

However, the models manufactured from these resins are tough to incise or suture and are not suitable for practice.

Conversely, hydrogels derived from natural food such as Japanese gelatin and Konnyaku, which is a rubbery traditional food and is made from Konjac, can be cut or incised by a medical energy device but are too soft to reproduce the touch of incision or suture.

In an attempt to solve this problem, for example, a hydrogel has been proposed in Non-Patent Literature 1 which is tough and manufactured from sodium polyacrylate, clay, water, and a both dendron-terminated polymer.

### CITATION LIST

### Non-Patent Literature

[Non-PTL 1]

Wang et al., NATURE, Vol. 463, 21 Jan. 2010

### SUMMARY OF INVENTION

### Technical Problem

The present disclosure is to provide a hydrogel liquid precursor as a material for manufacturing a hydrogel fabrication product that has a certain level of compression stress and breakage limit and can be incised by an energy device such as an electrosurgical knife.

### Solution to Problem

The hydrogel liquid precursor of the present disclosure as a means to solve the problem contains the compound represented by Chemical Formula 1 and water.

R₁CH═CR₂X Chemical Formula 1

where X represents a carboxyl group, carboxylate group, sulfo group, or sulfonate group, R₁ and R₂ each independently represent hydrogen atoms, alkyl groups, aryl groups, carboxyl groups, or alkylcarboxy groups.

### Advantageous Effects of Invention

According to the present disclosure, a hydrogel liquid precursor is provided to manufacture a hydrogel fabrication product that has a certain level of compression stress and breakage limit and can be incised by an energy device such as an electrosurgical knife or sewn up.

### DESCRIPTION OF EMBODIMENT

The present disclosure is described with reference to embodiments. One aspect of the hydrogel liquid precursor of the present disclosure is the following (1), which includes (2) to (10). These are described in detail below.

(1) A hydrogel liquid precursor contains the compound represented by Chemical formula 1 or a salt thereof, and water.

R₁CH50 CR₂ X Chemical Formula 1,

where X represents a carboxyl group, carboxylate group, sulfo group, or sulfonate group, R₁ and R₂ each independently represent hydrogen atoms, alkyl groups, aryl groups, carboxyl groups, or alkylcarboxy groups.

(2) The hydrogel liquid precursor according to the (1) mentioned above further contains a polymerizable monomer.

(3) The hydrogel liquid precursor according to the (1) or (2) mentioned above further contains a mineral dispersible in water.

(4) The hydrogel liquid precursor according to any one of the (1) to (3) mentioned above further contains vinylsilane.

(5) The hydrogel liquid precursor according to any one of the (1) to (4) mentioned above is for manufacturing a hydrogel fabrication product.

(6) A method of manufacturing a hydrogel fabrication product includes forming a liquid film that forms a hydrogel liquid precursor liquid film using the hydrogel liquid precursor of any one of the (1) to (5) mentioned above, curing the hydrogel liquid precursor liquid film to form a layer, and repeating the forming and curing to laminate the layers.

(7) The method according to the (6) mentioned above, wherein the liquid film is formed by inkjet printing.

(8) A method of manufacturing a hydrogel fabrication product includes exposing the hydrogel liquid precursor of any one of the (1) to (5) mentioned above to light to cure the hydrogel liquid precursor to form a layer and repeating the exposing to sequentially form and laminate the layer to manufacture the hydrogel fabrication product.

(9) A method of manufacturing a hydrogel fabrication product includes infusing the hydrogel liquid precursor of any one of the (1) to (5) mentioned above into a mold, curing the hydrogel liquid precursor, and removing the mold.

(10) A hydrogel fabrication product contains a cured product of the hydrogel liquid precursor of any one of the (1) to (5) mentioned above.

### Hydrogel Liquid Precursor

The hydrogel liquid precursor of the present disclosure contains the compound represented by Chemical Formula 1 or a salt thereof, and water. It optionally contains other optional components.

R₁CH═CR₂ X Chemical Formula 1,

where X represents a carboxyl group, carboxylate group, sulfo group, or sulfonate group, R₁ and R₂ each independently represent hydrogen atoms, alkyl groups, aryl groups, carboxyl groups, or alkylcarboxy groups.

With this hydrogel liquid precursor, it is possible to manufacture a hydrogel fabrication product that has a certain level of compression stress and breakage limit and can be incised by an energy device such as an electrosurgical knife. The hydrogel liquid precursor of the present disclosure can be adjusted at particularly low viscosity and suitably used as a liquid for manufacturing a solid freeform fabrication product, preferably a liquid for manufacturing a solid freeform fabrication product manufactured by additive manufacturing, and in particular an ink composition for a solid freeform fabrication device using a discharging head such as an inkjet head utilizing an inkjet method.

### Compound Represented by Chemical Formula 1

The compound contained in the hydrogel liquid precursor of the present disclosure is represented by the following Chemical Formula 1.

R₁CH═CR₂X Chemical Formula 1

In Chemical Formula 1, X represents —COOA or —SO₂A, where A represents a hydrogen atom, an alkyl group, an aryl group or an alkylhydroxy group or carbonate thereof. The compound forms its main chain when polymerized upon irradiation of active energy rays.

R₁ and R₂ each independently represent hydrogen atoms, alkyl groups, aryl groups, carboxyl groups, or alkylcarboxy groups. The alkyl or alkyl group in the present disclosure means a linear or branched hydrocarbon group, preferably having maximally six carbon atoms. The aryl or aryl group in the present disclosure means an aromatic hydrocarbon group, which may include a single ring or condensed ring, and preferably an aromatic hydrocarbon group having maximally six carbon atoms.

The compound represented by Chemical Formula 1 or a salt thereof is not particularly limited and can be suitably selected to suit to a particular application. To obtain a fabrication object having excellent breaking stress and elongation ratio, the compound or salt preferably contains at least a metal salt of (meth)acrylic acid.

Specific examples of the compound represented by Chemical Formula 1 include, but are not limited to, unsaturated monocarboxylic acids such as acrylic acid, methacrylic acid, and crotonic acid, monoalkyl esters of unsaturated dicarboxylic acid such as itaconic acid, maleic acid, maleic anhydride, fumaric acid, monoalkyl esters of maleic acid, fumaric acid monoalkyl esters, and itaconic acid monoalkyl esters, an unsaturated dicarboxylic acid such as citraconic acid, phosphoric acid group-containing unsaturated monomers such as acid phosphooxyethyl (meth)acrylate, acid phosphooxy polyoxyethylene glycol mono(meth)acrylate, and acid phosphooxypolyoxy propylene glycol mono(meth)acrylates, 2-(meth)acryloyloxyethyl succinic acid, β-carboxyethyl(meth)acrylate, monohydroxyethyl (meth)acrylate phthalate, (meth)acryloyloxyethyl succinate, 2-propenoic acid, vinyl sulfonic acid, (meth)allyl sulfonic acid, 2-(meth)acrylamide-2-methylpropane sulfonic acid α-methylstyrene sulfonic acid, 2-(meth)acryloyloxyethyl phthalic acid, 3-(2-carboxyethoxy)-3-oxy propyl ester, 2-(meth)acryloyloxyethyl tetrahydrophthalic acid, 2-(meth)acryloyloxyethyl hexahydrophthalic acid, ω-carboxy-polycaprolactone (n=2) mono(meth)acrylate, glycerin mono(meth)acrylate, hydroxymethyl(meth)acrylate, hydroxyethyl(meth)acrylate, hydroxypropyl(meth)acrylate, hydroxybutyl(meth)acrylate, hydroxypentyl(meth)acrylate, hydroxyhexyl(meth)acrylate, hydroxyethyl vinyl ether, diethylene glycol mono vinyl ether, hydroxy butyl vinyl ether, polypropylene glycol mono(meth)acrylate, polyethylene glycol mono(meth)acrylate, and hydroxyethyl acrylamide.

Specific example of the metal salt of (meth)acrylic acid include, but are not limited to, potassium acrylate, zinc acrylate, potassium methacrylate, magnesium acrylate, calcium acrylate, zinc methacrylate, magnesium methacrylate, aluminum acrylate, neodymium methacrylate, sodium methacrylate, and sodium acrylate.

These can be used alone or in combination.

### Polymerizable Monomer

Polymeizable monomers may be added to the hydrogel liquid precursor in addition to the compound represented by Chemical Formula 1. The polymerizable monomer in the present disclosure forms a random copolymer together with the compound represented by Chemical formula 1. This random copolymer enhances the strength of a hydrogel fabrication object so that the model for practicing surgical procedure for medical staff has mechanical characteristics like those of a real organ.

The polymerizable monomer includes a mono-functional monomer and a multi-functional monomer.

### Mono-Functional Monomer

Examples of the mono-functional monomer include, but are not limited to, (meth)acrylamide derivatives such as acrylamide, methacrylamide, N-substituted acrylamide derivative, N,N-di-substituted acrylamide derivative, N-substituted methacrylamide derivative, N,N-di-substituted methacrylamide derivative, and other mono-functional monomers. These can be sed alone or in combination.

Specific examples of (meth)acrylamide derivatives include, but are not limited to, N, N-dimethyl acrylamide, N-isopropyl acrylamide, N-methylol acrylamide, acryloyl morpholine, dimethyl methacrylamide, N-isopropyl methacrylamide, N-methylol methacrylamide, and methacryloyl morpholine. These can be used alone or in combination. Of these, acryloyl morpholine and N, N-dimethyl acrylamide are preferable in terms of polymerization stability.

The other mono-functional monomers include, but are not limited to, acrylates, alkyl acrylates, methacrylates, and alkyl methacrylates.

Specific examples of the acrylate include, but are not limited to, hydroxyethyl acrylate, hydroxypropyl acrylate, dimethylaminoethyl acrylate, dimethylaminopropyl acrylate, and alkyl acrylate.

Specific examples of the alkyl acrylate include, but are not limited to, methyl acrylate, ethyl acrylate, butyl acrylate, and 2-ethylhexyl acrylate lauryl acrylate.

Specific examples of the methacrylate include, but are not limited to, hydroxyethyl methacrylate, hydroxypropyl methacrylate, dimethylaminoethyl methacrylate, dimethylaminopropyl methacrylate, and alkyl methacrylate.

Specific examples of the alkyl methacrylate include, but are not limited to, methyl methacrylate, ethyl methacrylate, butyl methacrylate, lauryl methacrylate, stearyl methacrylate, and glycidyl methacrylate.

Specific examples of the other mono-functional monomers include, but are not limited to, 2-etylhexyl(meth)acrylate (EHA), 2-hydroxyethyl(meth)acrylate (HEA), 2-hydroxypropyl(meth)acrylate (HPA), caprolactone-modified tetrahydrofurfuryl(meta)acrylate, isobonyl(meth)acrylate, 3-methoxybutyl(meth)acrylate, tetrahydro furfuryl(meth)acrylate, lauryl(meth)acrylate, 2-phenoxyethyl(meth)acrylate, isodecyl(meth)acrylate, isooctyl(meth)acrylate, tridecyl(meth)acrylate, caprolactone(meth)acrylate, and ethoxyfied nonylphenol(meth)acrylate. These can be used alone or in combination.

### Multi-Functional Monomer

The multi-functional monomer includes di-functional monomers or tri- or higher functional monomers.

The multi-functional monomer functions as a cross-linking agent that cross-links random copolymer molecules formed by the compound represented by Chemical formula 1 and a polymerizable monomer.

Specific examples of the di-functional monomer include, but are not limited to, tripropylene glycol di(meth)acrylate, triethylene glycol di(meth)acrylate, tetraethylene glycol di(meth)acrylate, polypropylene glycol di(meth)acrylate, neopentyl glycol hydroxy pivalic acid ester di(meth)acrylate (MANDA), hydroxypivalic acid neopentyl glycol ester di(meth)acrylate (HPNDA), 1,3-butane diol di(meth)acrylate (BGDA), 1,4-butane diol di(meth)acrylate (BUDA), 1,6-hexane diol di(meth)acrylate (HDDA), 1,9-nonane diol(meth)acrylate, diethylene glycol di(meth)acrylate (DEGDA), neopentyl glycol di(meth)acrylate (NPGDA), tripropylene glycol di(meth)acrylate (TPGDA), caprolactone-modified hydroxy pivalic acid neopentyl glycol ester di(meth)acrylate, propoxinated neopentyl glycol di(meth)acrylate, ethoxy-modified bisphenol A di(meth)acrylate, polyethylene glycol 200 di(meth)acrylate, and polyethylene glycol 400 di(meth)acrylate. These can be used alone or in combination.

Specific examples of the tri- or higher functional monomers include, but are not limited to, trimethylol propane tri(meth)acrylate (TMPTA), pentaerythritol tri(meth)acrylate (PETA), dipentaerythritol hexa(meth)acrylate (DPHA), triallyl isocyanate, (meth)acrylate of ε-caprolactone modified dipentaerythritol, tris(2-hydroxyethyl)isocyanulate tri(meth)acrylate, ethoxified trimethylol propane tri(meth)acrylate, propoxified trimethylol propane tri(meth)acrylate, propoxified glyceryl tri(meth)acrylate, pentaerythritol tetra(meth)acrylate, ditreimethylhol propanetetra(meth)acrylate, dipentaerythritol hydroxypenta(meth)acrylate, ethoxified(pentaerythritol tetra(meth)acrylate, and penta(meth)acrylate ester.

These can be used alone or in combination.

The proportion of the polymerizable monomer is preferably from 0.5 to 30 percent by mass to the total content of the hydrogel liquid precursor. A large proportion of the polymerizable monomer degrades incision ability of electrosurgical knife. It is preferably from 0.5 to 10 percent by mass.

### Mineral Dispersible in Water

Mineral dispersible in water may be added to the hydrogel liquid precursor in addition to the compound represented by Chemical Formula 1. This mineral enhances the strength of a hydrogel fabrication object so that the model for practicing surgical procedure for medical staff has mechanical characteristics like those of a real organ.

The mineral dispersible in water is not particularly limited and can be suitably selected to suit to a particular application. For example, lamellar mineral is suitable.

The lamellar mineral is preferably dispersed in water in a form of a single layer.

The laminate mineral has no particular limit and, for example, water swellable lamellar clay minerals are suitable.

Examples of such water swellable lamellar clay minerals are water swellable smectite and water swellable mica.

Specific examples include, but are not limited to, water swellable hectorite containing sodium as an interlayer ion, water swellable montmorillonite, water swellable saponite, and water swellable synthetic mica.

“Water swellable” means that water molecules are inserted between layers of lamellar mineral so that it can be dispersed in water.

The water swellable lamellar clay mineral mentioned above can be used alone or in combination. In addition, it is suitable to synthesize such a mineral and can also be procured.

Specific examples of the procurable product include, but are not limited to, synthetic hectorite (LAPONITE XLG, manufactured by RockWood Additives Ltd.), SWN (manufactured by Coop Chemical Ltd.), and fluorinated hectorite SWF (manufactured Coop Chemical Ltd.). Of these, synthetic hectorite is preferable.

The proportion of the mineral dispersible in water in the total mass of the liquid composition is preferably from 1 to 40 percent by mass and more preferably from 1 to 15 percent by mass.

### Vinylsilane

Vinylsilane may be added to the hydrogel liquid precursor in addition to the compound represented by Chemical Formula (1). Vinylsilane enhances the strength of a hydrogel fabrication object so that the model for practicing surgical procedure for medical staff has mechanical characteristics like those of a real organ.

Specific examples of vinylsilane include, but are not limited to, 1-bromovinyl)trimethylsilane,1,4-bis(dimethylvinylsilyl)benzene,clorodimethylvinylsilane, chloro(methyl)(phenyl)(vinyl)silane, dichloromethylvinylsilane,Dietoxymethylvinylsilane, 2-(dimethylvinylsilyl)pyridine, dimethoxymethylvinylsilane, dimethylidinylsilane,3-[Dimethyl(vinyl)silyl]oxy-1,5,5-tetramethyl-3-phenyl-1,5-divinyltrisiloxane,1,3-dimethyl-1,3-diphenyl-1,3-divinyldisiloxane, dimethylphenylvinylsilane,octavinyloctasilasesquioxane, triphenylvinylsilane,triethylvinylsilane, 2,4,6,8-tetramethyl-2,4,6,8-tetravinylcyclotetrasiloxane, 2,4,6-trimethyl-2,4,6-trivinylcyclotrisilazane,trimethylsilylketene, ethyl trimethylsilyl acetal (mixture of isomers), (E)-trimethyl(3,3,3-trifluoro-1-propenyl)silane,tetrakis[dimethyl(vinyl)silyl]orthosilicate, 2,4,6-trimethyl-2,4,6-trivinylcyclotiloxane, and vinyl trimethylsilane.

The proportion of vinylsilane in the total mass of the liquid composition is preferably from 0.01 to 5 percent by mass and more preferably from 0.01 to 1 percent by mass.

### Solvent

Water is preferably used as the main solvent. With this main solvent, a solid freeform fabrication product is manufactured as a hydrogel.

Water may contain an organic solvent compatible with water.

The proportion of the solvent in the total content of the hydrogel liquid precursor is preferably 10 percent by mass or more and more preferably 60 percent by mass or more. In addition, the proportion is preferably 90 percent by mass or less and more preferably 80 percent by mass or less.

Water is used as the main solvent of the hydrogel.

There is no specific limitation to the water and it can be suitably selected to suit to a particular application. For example, pure water such as deionized water, ultrafiltered water, reverse osmosis water, and distilled water, and ultra pure water are suitable.

It is suitable to dissolve or disperse other components such as organic solvents in the water to impart moisture retention, antibiotic property, or electroconductive property, and adjust hardness.

### Other Components

The other optional components have no particular limit and can be suitably selected to suit to a particular application. For example, stabilizers, surface treatment chemicals, polymerization initiators, coloring materials, viscosity modifiers, adhesion imparting agents, antioxidants, anti-aging agents, cross-linking promoters, ultraviolet absorbents, plasticizers, preservatives, and dispersants.

### Stabilizer

Stabilizers are optionally used to stabilize properties as liquid. Stabilizers include, for example, highly concentrated phosphates, glycols, and non-union surfactants.

### Surface Treatment Chemical

Specific examples of the surface treatment chemical include, but are not limited to, a polyester resin, a polyvinyl acetate resin, a silicone resin, a coumarone resin, an ester of an aliphatic acid, glyceride, and wax.

### Polymerization Initiator

Examples of the polymerization initiator include, but are not limited to, thermal polymerization initiators and photopolymerization initiators. Photopolymerization initiators are used for stereolithography and both photopolymerization initiators and thermal polymerization initiators are used for cast fabrication.

As the photopolymerization initiator, any material can be used which produces a radical upon irradiation of light (ultraviolet rays in a wavelength range of from 220 to 500 nm). Specific examples of the polymerization initiator include, but are not limited to, acetophenone, 2,2-diethoxyacetophenone, p-dimethylaminoacetophenone, benzophenone, 2-chlorobenzophenone, p,p′-dichlorobenzophenone, p,p-bisdiethylaminobenzophenone, Michler's ketone, benzyl, benzoin, benzoin methyl ether, benzoin ethyl ether, benzoin isopropyl ether, benzoin-n-propyl ether, benzoin isobutyl ether, benzoin-n-butyl ether, benzyl methyl ketal, thioxanthone, 2-chlorothioxanthone, 2-hydroxy-2-methyl-1-phenyl-1-one, 1-(4-isopropylphenyl)2-hydroxy-2-methylpropan-1-one, methyl benzoylformate, 1-hydroxycyclohexyl phenyl ketone, azobis(isobutylonitrile), benzoyl peroxide, and di-tert-butyl peroxide. These can be used alone or in combination.

The thermal polymerization initiator has no particular limitation and can be suitably selected to suit to a particular application. Examples thereof are azo-based initiators, peroxide initiators, persulfate initiators, and redox (oxidation-reduction) initiators.

Azo-Based Initiators can be Procured.

Specific example of the commercial products include, but are not limited to, VA-044, VA-46B, VA-50, VA-057, VA-061, VA-067, VA-086, 2,2′-azobis(4-methoxy-2,4-dimethylvaleronitrile) (VAZO® 33), 2,2′-azobis(2-amidinopropane)dihydrochloride (VAZO® 50), 2,2′-azobis(2,4-dimetaylvaleronitrile) (VAZO® 52), 2,2′-azobis(isobutylonitrile) (VAZO® 64), 2,2′-azobis-2-methylbutylonitrile) (VAZO® 67), and 1,1-azobis(1-cyclohexane carbonitrile) (VAZO® 88) (all available from E.I. du Pont de Nemours and Company), 2,2′-azobis(2-cyclopropylpropionitrile), and 2,2′-azo-bis(methylisobutylate) (V-601) (all available from FUJIFILM Wako Pure Chemical Corporation).

Specific examples of the peroxide initiator include, but are not limited to, benzoyl peroxide, acetyl peroxide, lauroyl peroxide, decanoyl peroxide, dicetyl peroxy dicarbonate, di(4-t-butylcyclohexyl)peroxy dicarbonate (PERKADOX® 16S) (available from Akzo Nobel N.V.), di(2-ethylhexyl)peroxy dicarbonate, t-butyl peroxypivalate (LUPERSONL® 11) (all available from Elf Atochem S.A), t-butylperoxy-2-ethyl hexanoate (TRIGONOX® 21-050) (available from Akzo Nobel N.V), and dicumyl peroxide.

Specific examples of the persulfate initiator include, but are not limited to, potassium persulfate, sodium persulfate, and ammonium persulfate.

Specific examples of redox (oxidation-reduction) initiator include, but are not limited to, a combination of the persulfate initiator and a reducing agent such as sodium metabisulfite and sodium bisulfite, a system based on the organic peroxide and tertiary amine (such as a system based on benzoyl peroxide and dimethylaniline), and a system based on organic hydroperoxide and transition metal (such as a system based on cumenhydroperoxide and cobalt naftate).

### Coloring Material

As the coloring material, various pigments and dyes can be used, which impart black, white, magenta, cyan, yellow, green, orange, and gloss color such as gold and silver.

An inorganic or organic pigment can be used alone or in combination as the pigment.

Specific examples of the inorganic pigment include, but are not limited to, carbon blacks (C.I. PIGMENT BLACK 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments, polycyclic pigments such as phthalocyanine pigments, perylene pigments, perinone pigments, anthraquinone pigments, quinacridone pigments, dioxane pigments, thioindigo pigments, isoindolinone pigments, and quinofuranone pigments, dye chelates such as basic dye type chelates and acid dye type chelates, dye lakes such as basic dye type lake and acid dye type lake, nitro pigments, nitroso pigments, aniline black, and daylight fluorescent pigments.

In addition, the coloring material may furthermore optionally contain a dispersant to enhance the dispersibility of the pigment. The dispersant has no particular limit. For example, it is suitable to use a polymer dispersant conventionally used to prepare a pigment dispersion. The dye includes, for example, an acidic dye, direct dye, reactive dye, basic dye, and a combination thereof.

Note that when the coloring material is used in the material jetting method, a full-color fabrication object can be manufactured by using each color material having such colors as black, cyan, magenta, yellow and white.

The proportion of the coloring material in the total mass of the hydrogel liquid precursor is not particularly limited and can be suitably determined to suit to desired color density and dispersibility in the hydrogel liquid precursor. It is preferably from 0.1 to 20 percent by mass.

The hydrogel liquid precursor of the present disclosure can be prepared using the various components mentioned above. The preparation device and conditions are not particularly limited. One way of preparing the hydrogel liquid precursor is loading and mixing the compound represented by Chemical formula 1, water, a polymerizable monomer, and other components in a dispersing machine such as a ball mill, a kitty mill, a disc mill, a pin mill, and a Dyno mill.

### Viscosity

The viscosity of the hydrogel liquid precursor is not particularly limited.

When the hydrogel liquid precursor is used with the material jetting method, the viscosity is preferably from 3 to 60 mPa·s and more preferably from 6 to 30 mPa·s at 25 degrees C. A viscosity less than 3 mPa·s makes discharging unstable such that the liquid is discharged not in a straight manner or not discharged during fabrication. When viscosity exceeds 40 mPa·s, the liquid may not be discharged. In addition, the viscosity of the hydrogel liquid precursor can be adjusted to those ranges by changing the temperature of an inkjet head.

When the hydrogel liquid precursor is used in the stereolithography method, the viscosity thereof at 25 degrees C. is preferably 50 mPa·s or more, more preferably 100 mPa·s or more, and furthermore preferably 200 mPa·s or more in order to maintain a cured product stable in a fabrication tank. In terms of ease of handling, it is preferably 20,000 mPa·s or less, more preferably 15,000 mPa·s or less, and furthermore preferably 12,000 mPa·s or less.

In addition, the viscosity of the hydrogel liquid precursor can be adjusted to those ranges by changing the temperature of the fabrication tank.

When the hydrogel liquid precursor is used with the cast molding method, the viscosity is preferably from 3 to 1,000 mPa·s and more preferably from 3 to 100 mPa·s at 25 degrees C. A viscosity surpassing 1,000 mPa·s degrades the handling property of the hydrogel liquid precursor when the hydrogel liquid precursor is infused into a mold because the viscosity is high.

Viscosity can be measured by, for example, a rotation viscometer (VISCOMATE VM-150 III, manufactured by TOKI SANGYO CO., LTD.) in a 25 degrees C. environment. Viscosity can be adjusted, for example, by mixing monomers, minerals dispersed in a solvent, or solvents having different viscosities.

### Method of Manufacturing Hydrogel Fabrication Product

The hydrogel fabrication product can be manufactured from the hydrogel liquid precursor of the present disclosure by methods described in the following first to third embodiments.

### Manufacturing Method in First Embodiment

The method of manufacturing a hydrogel fabrication product includes forming a liquid film of the hydrogel liquid precursor, curing the liquid film to form a layer, and repeating the forming a liquid film and curing the liquid film to laminate the layer. The method may include other optional processes. The liquid film is preferably formed by an inkjet printing method, which is referred to as the material jetting method in general.

The method of manufacturing a hydrogel fabrication product of the first embodiment may have many heads to jet color ink and other resin materials at the same time so that a hybrid fabrication product from the color ink and the resin materials can be fabricated.

In the method of manufacturing a hydrogel fabrication object of the first embodiment, each process is repeated multiple times. The number of the repetition of each process is not simply determined because the number depends on the size, form, and structure of a 3D fabrication object to be manufactured. However, if the thickness per layer is in the range of from 10 to 50 μm, objects having a good precision can be fabricated free of peeling-off. Therefore, forming a layer is repeated until the thickness of stacked layers reaches the height of the hydrogel fabrication object to be manufactured.

### Liquid Film Forming Process and Liquid Film Forming Device

The liquid film forming process includes applying a hydrogel liquid precursor containing the compound represented by Chemical formula 1 and water to form a liquid film of the hydrogel liquid precursor, which is executed by a liquid film forming device.

The hydrogel liquid precursor preferably contains a polymerizable monomer, a mineral dispersible in water, or vinylsilane to enhance its strength.

The liquid film forming device is not particularly limited and can be suitably selected to suit to a particular application. For example, the device employing a spraying method, an inkjet printing methods, or a dispenser method is suitable. Known devices are suitably used to execute these methods.

Of these, the dispenser method has an excellent quantitative property but difficulty in achieving a wide application area. The spray method is capable of simply forming a fine discharging material, has a wide application area, and demonstrates excellent applicability but the quantitative property thereof is poor, which causes scattering due to the spray stream. For this reason, in the present disclosure, the inkjet printing method is particularly preferable. The inkjet printing method has a good quantitative property in comparison with the spray method and a wider application area in comparison with the dispenser method. Accordingly, the inkjet printing method is preferable to accurately and efficiently form a complex solid shape.

Inkjet stereolithography devices can be procured. A specific example is AGILISTA (manufactured by KEYENCE CORPORATION).

### Manufacturing Method in Second Embodiment

The manufacturing method of the second embodiment is stereolithography.

The stereolithography is characterized by exposing the hydrogel liquid precursor to light to cure the hydrogel liquid precursor to form a layer followed by sequentially forming and stacking the layer to manufacture a hydrogel fabrication product.

Each layer of the laminate is obtained by exposing the liquid surface of a hydrogel liquid precursor to light. The liquid surface can be smoothed by a device such as a recoater. If the liquid surface is selectively exposed, a cured product (cross section cured layer) having a cross section of a desired pattern is obtained.

In the method of manufacturing a hydrogel fabrication product of the second embodiment, the liquid surface of a hydrogel liquid precursor is exposed to light to form a cured product (cross section cured layer) of the hydrogel liquid precursor. The hydrogel liquid precursor is supplied onto the cured product followed by exposing it to light to form another cured product. This is repeated until a hydrogel fabrication product integrated by laminating the multiple cured product is fabricated.

The device for selectively exposing a hydrogel liquid precursor to light is not particularly limited and includes various types of devices. Such devices include: (a) an irradiator that irradiates a hydrogel liquid precursor with laser beams or light converged by using lenses and mirrors; (b) an irradiator that irradiates a hydrogel liquid precursor with non-converged light via a mask having a light transmission unit to transmit light having a particular pattern; (c) an irradiator that irradiates a hydrogel liquid precursor with light via many optical fibers supporting a particular pattern at a light guiding member binding the optical fibers; and (d) a device that repeats exposing a hydrogel liquid precursor to light per region at once.

For the device (b) using the mask mentioned above, it is possible to use a mask electrooptically creating a mask image formed of a light transmission region and a non-light transmission region based on a particular pattern according to the same principle as that of a liquid crystal display.

It is preferable to adopt a device to scan laser beams having a small spot diameter as the irradiator that selectively irradiates a hydrogel liquid precursor for a hydrogel fabrication product as a target having a fine portion or requiring a high dimension accuracy.

When a hydrogel liquid precursor is accommodated in a light-transmissive container, the surface exposed to light (ex. surface scanned with converged light) can be either of the liquid surface of the hydrogel liquid precursor or the contact surface with the wall of the container. In either case, it is possible to irradiate the hydrogel liquid precursor in the container directly from outside or via the wall.

The hydrogel fabrication product of the present disclosure can be manufactured by an optical solid freeform fabrication method such as stereolithography. In the stereolithography, a particular part of a hydrogel liquid precursor is cured and then the exposure position by light (exposed surface) is moved from the cured part to an uncured part continuously or step by step to laminate the cured part to produce a desired solid object. The exposure position can be moved by various methods including moving one of the light source, the container of a hydrogel liquid precursor, and the cured part of a hydrogel liquid precursor, and additionally supply a hydrogel liquid precursor to the container.

Stereolithography devices can be procured. An example of the procurable stereolithography device is FORM2 (manufactured by Formlabs).

### Manufacturing Method in Third Embodiment

The method of manufacturing a hydrogel fabrication product of the third embodiment includes, but are not limited to, a cast molding method.

Molds are manufactured as a template in the cast molding method. Molds can be manufactured with a 3D printer utilizing material jetting, stereolithography, binder jetting, fused deposition molding (FDM). Molds can also be obtained utilizing computerized numerical control (CNC) cutting.

The hydrogel liquid precursor mentioned above is infused into the hollow part inside the manufactured mold by such processes and methods. The hydrogel liquid precursor is simply cured upon application of ultraviolet (UV) radiation by a UV lamp with a photopolymerization initiator for a mold made of a transmissive resin.

The hydrogel liquid precursor is cured upon application of heat with a heat polymerization initiator for a mold made of a non-transmissive resin.

After the hydrogel liquid precursor is cured by one of these methods, the mold is peeled off or broken to take out of a hydrogel fabrication product.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Example 1

### Preparation of Hydrogel Liquid Precursor

A total of 59.9 parts of potassium acrylate (manufactured by Nippon Shokubai Co., Ltd.), 40.0 parts of pure water, and 0.1 parts of ammonium persulfate (manufactured by Wako Pure Chemical Industries, Ltd.) as an initiator were admixed and stirred followed by filtering to remove impurities. Finally, the resulting substance was subjected to vacuum degassing for 10 minutes to obtain a hydrogel liquid precursor as a homogeneous liquid.

### Manufacturing of Test Model for Breakage Limit: Mold Fabrication

A test pattern (dumbbell-shaped 3, based on JIS K 6251 format) having a depth of 5 mm was produced from a polytetrafluoroethylene (PTFE) block by cutting. The test pattern was filled with the hydrogel liquid precursor and allowed to rest in a nitrogen atmosphere for 24 hours. The thus-obtained test piece was subjected to the following to measure the breakage limit thereof.

### Manufacturing of Test Model for Compression Stress: Mold Fabrication

A test pattern (30 mm××30 mm×10 mm) was produced from a polytetrafluoroethylene (PTFE) block by cutting. The test pattern was filled with the hydrogel liquid precursor and allowed to rest at room temperature in a nitrogen atmosphere for 24 hours to cure. A hydrogel fabrication object of 30 mm×30 mm×10 mm was obtained. The thus-obtained hydrogel fabrication object was subjected to a compression stress test according to the following method.

### Manufacturing of Model for Practicing Surgical Procedure for Incision and Suture Testing: Mold Fabrication

A casting mold was manufactured imitating the substantial part of a kidney using a stereolithography fabrication device (FORM 2, manufactured by Formlabs). The hydrogel liquid precursor was charged in the mold and allowed to rest in a nitrogen atmosphere for 24 hours to cure. The mold was removed to produce a model for practicing surgical procedure imitating a kidney. The model was subjected to incision testing using an electrosurgical knife and suture testing using a surgical suture.

### Example 2

### Preparation of Hydrogel Liquid Precursor

A total of 49.9 parts of potassium acrylate (manufactured by Nippon Shokubai Co., Ltd.), 40.0 parts of pure water, 10.0 parts of dimethyl acrylamide (manufactured by KJ Chemicals Corporation) as a polymerizable monomer, and 0.1 parts of ammonium persulfate (manufactured by Wako Pure Chemical Industries, Ltd.) as an initiator were admixed and stirred followed by filtering to remove impurities. Finally, the resulting substance was subjected to vacuum degassing for 10 minutes to obtain a hydrogel liquid precursor as a homogeneous liquid.

A test model for breakage limit, test model for compression stress, and model for practicing surgical procedure were manufactured in the same manner as in Example 1 and subjected to a test for breakage limit, test for compression stress, incision test by electrosurgical knife, and suture test using a surgical suture.

### Example 3

### Preparation of Hydrogel Liquid Precursor

A total of 7.0 parts of synthetic hectorite (LAPONITE RD, manufactured by Rockwood Additives Ltd.) having a composition of [Mg_{5.34}Li_{0.66}SiO₈O₂₀(OH)₄]Na⁻_{0.66} as a lamellar clay mineral was slowly added to 40.0 parts of pure water while the pure water was stirred and 0.3 parts of etidronic acid (manufactured by Tokyo Chemical Industry Co. Ltd.) was added as a dispersant to prepare a liquid dispersion.

Thereafter, 52.6 parts of potassium acrylate (manufactured by Nippon Shokubai Co., Ltd.) was added to the obtained liquid dispersion.

A total of 0.1 parts of ammonium persulfate (manufactured by Wako Pure Chemical Industries, Ltd.) as an initiator was admixed and stirred followed by filtering to remove impurities. Finally, the resulting substance was subjected to vacuum degassing for 10 minutes to obtain a hydrogel liquid precursor as a homogeneous liquid.

A test model for breakage limit, test model for compression stress, and model for practicing surgical procedure were manufactured in the same manner as in Example 1 and subjected to a test for breakage limit, test for compression stress, incision test by electrosurgical knife, and suture test using a surgical suture.

### Example 4

### Preparation of Hydrogel Liquid Precursor

A total of 58.0 parts of potassium acrylate (manufactured by Nippon Shokubai Co., Ltd.), 40.0 parts of pure water were stirred, and then 1.9 parts of triethoxy vinylsilane (manufactured by Wako Pure Chemical Industries, Ltd.) were added followed by stirring for 30 minutes. Thereafter, 0.1 parts of ammonium persulfate (manufactured by Wako Pure Chemical Industries, Ltd.) as an initiator was added and stirred followed by filtering to remove impurities. Finally, the resulting substance was subjected to vacuum degassing for 10 minutes to obtain a hydrogel liquid precursor as a homogeneous liquid.

A test model for breakage limit, test model for compression stress, and model for practicing surgical procedure were manufactured in the same manner as in Example 1 and subjected to a test for breakage limit, test for compression stress, incision test by electrosurgical knife, and suture test using a surgical suture according to the following method.

### Example 5

### Preparation of Hydrogel Liquid Precursor

A hydrogel liquid precursor was prepared in the same manner as in Example 4 except that 0.1 parts of 1-hydroxycyclohexyl phenyl ketone (IRGACURE® 184, manufactured by BASF SE) was used as an initiator instead of ammonium persulfate.

### Fabrication by Inkjet (Material Jetting Method)

A test model for breakage limit, test model for compression stress, and model for practicing surgical procedure were directly manufactured in the same shape as in Example 1 using a 3D printer (MateriART-3DU 1, manufactured by MICROJET Corporation) utilizing material inkjetting and the hydrogel liquid precursor mentioned above as a modeling agent and subjected to a test for breakage limit, test for compression stress, incision test by electrosurgical knife, and suture test using a surgical suture according to the following method.

### Example 6

### Preparation of Hydrogel Liquid Precursor

A hydrogel liquid precursor was prepared in the same manner as in Example 4 except that 0.1 parts of 1-hydroxycyclohexyl phenyl ketone (IRGACURE® 184, manufactured by BASF SE) was used as an initiator instead of ammonium persulfate.

### Fabrication by Stereolithography

A test model for breakage limit, test model for compression stress, and model for practicing surgical procedure were directly manufactured in the same shape as in Example 1 using a 3D printer (Form2, manufactured by Formlab) utilizing stereolithography and the hydrogel liquid precursor mentioned above as a fabrication ink and subjected to a test for breakage limit, test for compression stress, incision test by electrosurgical knife, and suture test using a surgical suture according to the following method.

### Comparative Example 1

### Preparation of Hydrogel Liquid Precursor

A total of 59.9 parts of dimethyl acrylamide (manufactured by KJ Chemicals Corporation), 40.0 parts of pure water, and 0.1 arts of ammonium persulfate (manufactured by Wako Pure Chemical Industries, Ltd.) as an initiator were admixed and stirred followed by filtering to remove impurities. Finally, the resulting substance was subjected to vacuum degassing for 10 minutes to obtain a hydrogel liquid precursor as a homogeneous liquid.

A test model for breakage limit, test model for compression stress, and model for practicing surgical procedure were manufactured in the same manner as in Example 1 and subjected to a test for breakage limit, test for compression stress, incision test by electrosurgical knife, and suture test using a surgical suture.

### Comparative Example 2

A test model for breakage limit, test model for compression stress, and model for practicing surgical procedure were directly manufactured in the same shape as in Example 1 using a 3D printer (AGILISTA, manufactured by KEYENCE CORPORATION) utilizing material inkjet method and a modeling agent (AR-M2, manufactured by KEYENCE CORPORATION) and subjected to a test for breakage limit, test for compression stress, incision test by electrosurgical knife, and suture test using a surgical suture according to the following method.

### Comparative Example 3

A test model for breakage limit, test model for compression stress, and model for practicing surgical procedure were directly manufactured in the same shape as in Example 1 using a 3D printer (Form2, manufactured by Formlab) utilizing stereolithography and a clear resin (manufactured by Formlabs) and subjected to a test for breakage limit, test for compression stress, incision test by electrosurgical knife, and suture test using a surgical suture according to the following method.

### Evaluation on Breakage Limit

The test model for breakage limit of each Example and Comparative Example was tested by a tensile strength tester (AG-10kNX, manufactured by Shimadzu Corporation) according to JIS K 6251 format at a tensile speed of 500 mm/min. The elongation ratio was calculated based on a change between marked lines during the tensile testing to evaluate the breakage limit. The samples used in the tester which were not deformed even over a measuring limit of 10 kN and determined as error were not counted in the evaluation.

### Evaluation on Breaking Stress

The compression tester and the measuring method for use in the evaluation for compression stress were as follows.

A universal tester (AG-1, manufactured by Shimadzu Corporation), a load cell 1 kN, and a compression jig for 1 kN were provided to analyze the test model for compression stress of each of Examples and Comparative Examples. The computer recorded the stress from the compression applied to the load cell and plotted the stress for the amount of displacement to evaluate the compression stress at 60 percent compression. The samples used in the tester which were not deformed even over a measuring limit of 1 kN and determined as error were not counted in the evaluation.

### Evaluation on Energy Device Applicability and Suture Possibility

The model for practicing surgical procedure of each of Examples and Comparative Examples were subjected to incision testing using an electrosurgical knife as an energy device and suture testing using surgical suture.

An electrosurgical knife PROG (DS3M, manufactured by J. MORITA CORP.) with a C-1 tip was used in the incision testing. The tip was pressed against the model after the mode was set in CUT MODE to cut in the model with a length of 30 mm and a depth of 10 mm. The model was graded A when the model was successfully cut open while the model was burnt and graded B when the model did not react or the tip could not cut through.

In the suture testing, the sample was cut open with a length of 30 mm and a depth of 10 mm using a cutter knife. After the cut was sewn three times with a surgical suture (LTR-1, surgical thread with a needle for practice, manufactured by Fujimori Sangyo Co., Ltd.) using the needle in a zigzag manner bridging the cut, whether it was possible to lift the model with both ends pinched. The model was graded A when it was possible to lift the model and graded B when the model was torn during sewing or when the model was broken and the thread was off or when the model was too hard to pierce with the needle.

The evaluation results are shown in Table 1.

TABLE 1

| | | Example | | | | | |
|---|---|---|---|---|---|---|---|
| | | 1 | 2 | 3 | 4 | 5 | 6 |
| Formulation | Pure water | 40.0 | 40.0 | 40.0 | 40.0 | 40.0 | 40.0 |
| | Potassium | 59.9 | 49.9 | 52.6 | 58.0 | 58.0 | 58.0 |
| | acrylate | | | | | | |
| | Dimethyl | | 10.0 | | | | |
| | acrylamide | | | | | | |
| | Triethoxy | | | | 1.9 | 1.9 | 1.9 |
| | vinylsilane | | | | | | |
| | LAPONITE | | | 7.0 | | | |
| | RD | | | | | | |
| | Etidronic acid | | | 0.3 | | | |
| | Ammonium | 0.1 | 0.1 | 0.1 | 0.1 | | |
| | persulfate | | | | | | |
| | IRGACURE ® | | | | | 0.1 | 0.1 |
| | 184 | | | | | | |
| Total (parts) | | 100.0 | 100.0 | 100.0 | 100.0 | 100.0 | 100.0 |
| Fabrication Method | | Cast | Cast | Cast | Cast | Inkjet | SLA |
| | | molding | molding | molding | molding | | |
| Evaluation | Breakage limit | 230 | 310 | 530 | 480 | 510 | 470 |
| result | Compression | 0.4 | 0.5 | 0.8 | 0.9 | 0.8 | 1.1 |
| | stress (MPa) | | | | | | |
| | Incised with | A | A | A | A | A | A |
| | electrosurgical | | | | | | |
| | knife | | | | | | |
| | Suture | B | B | A | A | A | A |

| | | Comparative Example | | |
|---|---|---|---|---|
| | | 1 | 2 | 3 |
| Formulation | Pure water | 40.0 | | |
| | Potassium | | | |
| | acrylate | | | |
| | Dimethyl | 59.9 | | |
| | acrylamide | | | |
| | Triethoxy | | | |
| | vinylsilane | | | |
| | LAPONITE | | | |
| | RD | | | |
| | Etidronic acid | | | |
| | Ammonium | 0.1 | | |
| | persulfate | | | |
| | IRGACURE ® | | | |
| | 184 | | | |
| Total (parts) | | 100.0 | | |
| Fabrication Method | | Cast | Cast | Cast |
| | | molding | molding | molding |
| Evaluation | Breakage limit | 250 | Out of | Out of |
| result | | | evaluation | evaluation |
| | | | (error) | (error) |
| | Compression | 0.3 | Out of | Out of |
| | stress (MPa) | | evaluation | evaluation |
| | | | (error) | (error) |
| | Incised with | B | B | B |
| | electrosurgical | | | |
| | knife | | | |
| | Suture | B | B | B |

As seen in the results shown in Table 1, electrosurgical knives are fit in Examples 1 to 6 in comparison with Comparative Examples 1 to 3. The models in Examples 3 to 6 were able to be sutured.

In comparison with Comparative Example 1, the breakage limit and compression stress are high in Examples 2 to 6.

The models of Comparative Examples 2 and 3 were extremely stiff and not suitable as a model for surgical procedure.

Having now fully described embodiments of the present invention, it will be apparent to one of ordinary skill in the art that many changes and modifications can be made thereto without departing from the spirit and scope of embodiments of the invention as set forth herein.

This patent application is based on and claims priority to Japanese Patent Application No. 2019-216938, filed on Nov. 29, 2019, in the Japan Patent Office, the entire disclosure of which is hereby incorporated by reference herein.

1. A hydrogel liquid precursor, comprising:
one of a compound or a salt thereof represented by R₁CH═CR₂X, wherein X represents a carboxyl group, carboxylate group, sulfo group, or sulfonate group, and R₁ and R₂ each independently represent hydrogen atoms, alkyl groups, aryl groups, carboxyl groups, or alkylcarboxy groups; and
water.

2. The hydrogel liquid precursor according to claim 1, further comprising a polymerizable monomer.

3. The hydrogel liquid precursor according to claim 1, further comprising a mineral dispersible in water.

4. The hydrogel liquid precursor according to claim 1, further comprising vinylsilane.

5. The hydrogel liquid precursor according to claim 1, wherein the hydrogel liquid precursor is for manufacturing a hydrogel fabrication product.

6. A method of manufacturing a hydrogel fabrication product, comprising:
forming a liquid film of the hydrogel liquid precursor of claim 1;
curing the liquid film to form a layer; and
repeating the forming and the curing to laminate the layer.

7. The method according to claim 6, wherein the liquid film is formed by inkjet printing,

8. A method of manufacturing a hydrogel fabrication product, comprising:
exposing the hydrogel liquid precursor of claim 1 to light to cure the hydrogel liquid precursor to form a layer; and
repeating the exposing to sequentially form and laminate the layer.

9. A method of manufacturing a hydrogel fabrication product, comprising:
infusing the hydrogel liquid precursor of claim 1 into a mold; and
curing the hydrogel liquid precursor; and
removing the mold.

10. A hydrogel fabrication product, comprising:
a hydrogel formed by curing the hydrogel liquid precursor of claim 1.
